(19) United States
(12) Patent Application Publication
(10) Pub. No.: US 2007/0057975 A1
(43) Pub. Date: Mar. 15, 2007

(54) Apparatus and method for manufacturing display device

(75) Inventors: Jae-Ho Oh, Seoul (KR); Seung-Woo Lee, Seoul (KR); Bong-Im Park, Cheonan-si (KR); Tae-Sung Kim, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/518,083

(22) Filed: Sep. 8, 2006

(30) Foreign Application Priority Data
Sep. 9, 2005 (KR) 10-2005-0084132

(51) Int. Cl. G09G 5/10

(52) U.S. Cl. 345/690

(57) ABSTRACT

An apparatus for manufacturing a display device that includes a driving device and a communication line connected to the driving device is presented. The apparatus includes: an image signal creating unit that creates image signals and transmits the image signals to the display device; a plurality of optical sensors receiving light emitted from the display device and generating sensing signals; another communication line that is connectable to the first communication line; and a signal processing unit that controls the image signal creating unit, receives the sensing signal, performs a predetermined process to create driving data for the display device, and transmits the driving data to the driving devices through the communication lines. With the appratus, it is possible to optimize driving data for the display device while taking a characteristic deviation of the display device into account.

### CROSS-REFERENCE TO RELATED APPLICATION

This application claims priority from and the benefit of Korean Patent Application No. 10-2005-0084132 filed in the Korean Intellectual Property Office on Sep. 9, 2005, the entire content of which is incorporated herein by reference.

### BACKGROUND OF THE INVENTION

(a) Field of the Invention

The present invention relates generally to an apparatus and a method for manufacturing a display device, and more particularly, to a manufacturing apparatus and a method for optimizing digital data for driving the display device.

(b) Description of the Related Art

In general, liquid crystal displays (LCDs) include two display panels that have pixel electrodes and a common electrode formed thereon, respectively, and a liquid crystal layer having dielectric anisotropy that is interposed between the two display panels. The pixel electrodes are arranged in a matrix, and are connected to switching elements such as thin film transistors (TFTs). A data voltage is substantially applied to rows of the pixel electrodes. The common electrode is formed on the entire surface of the corresponding display panel, and is supplied with a common voltage. The pixel electrode, the common electrode, and the liquid crystal layer interposed therebetween form a liquid crystal capacitor in a circuit structure. The liquid crystal capacitor and the switching element connected thereto constitute a unit pixel.

In the liquid crystal display, when a voltage is applied to the two electrodes, an electric field is generated in the liquid crystal layer. The intensity of the electric field is adjusted to control the transmittance of light passing through the liquid crystal layer, thereby obtaining a desired image. In this case, when the electric field is applied to the liquid crystal layer in one direction for a long time, deterioration occurs in the liquid crystal layer. To prevent such deterioration, the polarity of a data voltage with respect to the common voltage is inverted for every frame, every column, or every pixel.

However, when the polarity of the data voltage with respect to the common voltage is inverted, a flicker occurs on a screen of the display device due to asymmetry between a positive polarity and a negative polarity. To reduce the occurrence of flicker in manufacturing and test processes of the liquid crystal display, the resistance of a variable resistor is adjusted to regulate the common voltage. However, adjusting the resistance this way entails manual modulation of the common voltage by the operator, which causes a long manufacturing time. This method of common voltage regulation also entails manufacturing and testing of the display device by the operator using the naked eye, and results in low manufacturing accuracy and manufacturing errors.

Even when the same image data signal is supplied to the same type of liquid crystal displays, the display qualities of the display devices may be different from each other. This is because the liquid crystal displays may have different gamma characteristics from the viewpoint of process characteristics of the display devices.

There is a pressing need for a liquid crystal display capable of displaying a motion picture. However, since liquid crystal has a low response speed, it is difficult for the liquid crystal display to display a quality motion picture. Therefore, in order to compensate for the low response speed of the liquid crystal, a method of applying a data voltage to the pixel electrodes wherein the data voltage is lower than or higher than the data voltage corresponding to an input image signal (undershoot voltage or overshoot voltage). That is, reference correction image data with respect to input image signals of previous and current frames is predetermined by means of, for example, experiments and is then stored in, for example, a lookup table of a liquid crystal display. Then, the liquid crystal display corrects the input image signals based on the stored reference correction image data to generate an overshoot voltage or an undershoot voltage. However, when a conventional trial-and-error method is used to determine the reference correction image data, it takes a lot of time to measure and determine the luminance of the liquid crystal display, and it is difficult to create accurate reference correction image data since the determination is performed by the naked eye of a measurer. Even when the reference correction image data is determined by, for example, experiments, the compensation of image signals may not be accurately performed due to the characteristic deviation of the liquid crystal display.

### SUMMARY OF THE INVENTION

The present invention includes an apparatus and a method for optimizing a common voltage, a gray voltage, and reference correction image data of a display device while taking a characteristic deviation of each display device into account.

In one aspect, the present invention is an apparatus for manufacturing a display device that includes a driving device and a first communication line connected to the driving device. The apparatus includes: an image signal creating unit that creates image signals and transmits the image signals to the display device; a plurality of optical sensors receiving light emitted from the display device and generating sensing signals; a second communication line that is connectable to the first communication line; and a signal processing unit that controls the image signal creating unit, receives the sensing signal, performs a predetermined process to create driving data for the display device, and transmits the driving data to the driving devices through the first and second communication lines.

In another aspect, the present invention is a method of manufacturing a display device that includes a driving device and a communication line connected to the driving device. The method entails: transmitting image signals to the display device; receiving light emitted from the display device at a plurality of positions to generate a plurality of sensing signals; creating driving data for the display device based on the sensing signals; and transmitting the driving data to the driving devices through the communication line.

### BRIEF DESCRIPTION OF THE DRAWINGS

The accompanying drawings briefly described below illustrate exemplary embodiments of the present invention and, together with the description, serve to explain the principles of the present invention.

FIG. 1 is a block diagram illustrating a liquid crystal display.

FIG. 2 is an equivalent circuit diagram of a pixel of the liquid crystal display.

FIG. 3 is a block diagram illustrating driving devices connected to serial buses of the liquid crystal display.

FIG. 4 is a block diagram illustrating a manufacturing apparatus according to an exemplary embodiment of the present invention.

FIG. 5 is a schematic diagram illustrating an optical sensor module of a manufacturing apparatus according to an exemplary embodiment of the present invention.

FIG. 6 is a schematic diagram illustrating one optical sensor of the optical sensor module shown in FIG. 5.

FIG. 7 is a schematic diagram illustrating a jig for supporting an optical sensor module according to an exemplary embodiment of the present invention.

FIG. 8 is a flowchart illustrating a method of manufacturing a liquid crystal display according to an exemplary embodiment of the present invention.

FIG. 9 is a flowchart illustrating a method of adjusting a common voltage of a liquid crystal display according to an exemplary embodiment of the present invention.

FIGS. 10A to 10C are schematic diagrams illustrating flicker patterns for adjusting a common voltage of a liquid crystal display.

FIG. 11 is a graph illustrating a flicker level of digital common voltage data.

FIGS. 12A and 12B are examples of the graph shown in FIG. 11 and show a method of extracting optimum digital common voltage data in consideration of the average and the deviation.

FIG. 13 is a flowchart illustrating a method of setting a gray voltage according to an exemplary embodiment of the present invention.

FIG. 14 is a diagram illustrating an example of a test image pattern for correcting an optical sensor module according to an exemplary embodiment of the present invention.

FIG. 15 is a diagram illustrating an example of a test image pattern for calculating a V-T characteristic of a liquid crystal display.

FIG. 16 is a flowchart illustrating a method of setting a gray voltage according to another exemplary embodiment of the present invention.

FIG. 17 is a schematic diagram illustrating the method of setting the gray voltage shown in FIG. 16.

FIG. 18 is a flowchart illustrating a method of obtaining reference correction image data according to an exemplary embodiment of the present invention.

FIG. 19 is a schematic diagram illustrating the structure of a lookup table having reference correction image data stored therein.

FIG. 20 is a diagram illustrating an example of a test image pattern for obtaining reference correction image data according to an exemplary embodiment of the present invention.

FIG. 21 is a schematic diagram illustrating a data signal for extracting a start time of one frame and a luminance response corresponding to the data signal.

FIGS. 22A and 22B are waveform diagrams illustrating a luminance response when a data signal varies.

FIG. 23 is a diagram illustrating a principle of calculating reference correction image data by means of interpolation according to an exemplary embodiment of the present invention.

FIG. 24 is a diagram illustrating an example of a method of calculating reference correction image data by interpolating data extracted according to an exemplary embodiment of the present invention.

FIG. 25 is a diagram illustrating reference correction image data calculated according to an exemplary embodiment of the present invention.

### DETAILED DESCRIPTION OF THE EMBODIMENTS

The present invention will be described more fully hereinafter with reference to the accompanying drawings, in which preferred embodiments of the invention are shown.

In the drawings, the thickness of layers, films, panels, regions, etc. are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

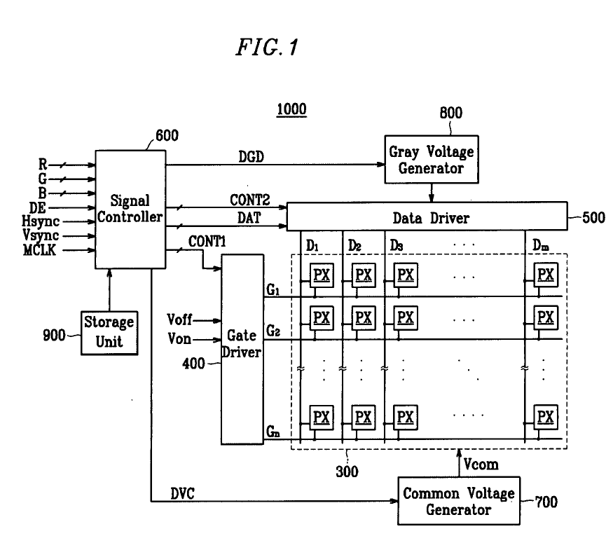

First, a liquid crystal display to be manufactured according to an exemplary embodiment of the present invention will be described in detail below with reference to FIGS. 1 to 3.

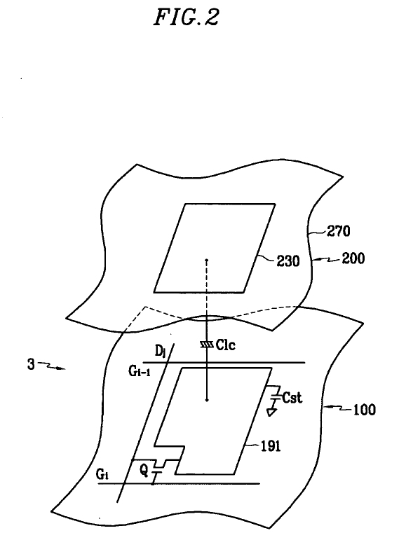

FIG. 1 is a block diagram illustrating a liquid crystal display, FIG. 2 is an equivalent circuit diagram of a pixel of the liquid crystal display and FIG. 3 is a block diagram illustrating a serial bus and a driving device connected to the serial bus of the liquid crystal display.

As shown in FIGS. 1 and 3, a liquid crystal display 1000 includes a liquid crystal panel assembly 300, a gate driver 400, a data driver 500, a common voltage generator 700, a gray voltage generator 800 connected to the data driver 500, a storage unit 900, a signal controller 600, and a serial bus 10 connecting the storage unit 900, the signal controller 600, the common voltage generator 700, and the gray voltage generator 800. The gate driver 400, the data driver 500, and the common voltage generator 700 are connected to the liquid crystal panel assembly 300, and the signal controller 600 controls the above-mentioned components.

In the equivalent circuit diagram, the liquid crystal panel assembly 300 is connected to a plurality of signal lines G₁ to Gₙ and D₁ to Dₘ and includes a plurality of pixels PX arranged substantially in a matrix. As seen from the structure shown in FIG. 2, the liquid crystal panel assembly 300 includes a lower panel 100, an upper panel 200 positioned in a plane substantially parallel to the plane of the lower panel 100, and a liquid crystal layer 3 interposed therebetween.

The signal lines G₁ to Gₙ and D₁ to Dₘ include a plurality of gate lines G₁ to Gₙ for transmitting gate signals (referred to as “scanning signals”) and a plurality of data lines D₁ to Dₘ for transmitting data signals. The gate lines G₁ to Gₙ extend substantially in a first direction and parallel to each other, and the data lines D₁ to Dₘ extend substantially in a second direction and parallel to each other. The first direction and the second direction are substantially parallel to each other.

For example, a pixel PX connected to an i-th (i=1, 2, . . . , n) gate line Gᵢ and a j-th (j=1, 2, . . . , m) data line Dⱼ includes a switching element Q connected to the signal lines Gᵢ and Dⱼ, a liquid crystal capacitor Clc connected to the switching element Q, and a storage capacitor Gst. The storage capacitor Cst may be omitted, if desired.

The switching element Q is a three-terminal element, such as a thin film transistor, and is provided on the lower panel 100. A control terminal of the switching element Q is connected to the gate line Gᵢ, an input terminal thereof is connected to the data line Dⱼ, and an output terminal thereof is connected to the liquid crystal capacitor Clc and the storage capacitor Cst.

The liquid crystal capacitor Clc has, as two terminals, a pixel electrode 191 on the lower panel 100 and a common electrode 270 on the upper panel 200, and also has the liquid crystal layer 3 between the two electrodes 191 and 270 as a dielectric. The pixel electrode 191 is connected to the switching element Q, and the common electrode 270 is formed on the entire surface of the upper panel 200 and is supplied with a common voltage Vcom. Unlike the structure shown in FIG. 2, the common electrode 270 may be provided on the lower panel 100. In this case, at least one of the two electrodes 191 and 270 may be formed in a linear or bar shape.

The storage capacitor Cst, serving as an auxiliary member of the liquid crystal capacitor Clc, is composed of a signal line (not shown) provided on the lower panel 100, the pixel electrode 191, and an insulator interposed therebetween. A predetermined voltage, such as a common voltage Vcom, is applied to the signal line.

Alternatively, the storage capacitor Cst may be a laminated structure of the pixel electrode 191, the insulator, and a previous gate line formed on the insulator.

Color display may be achieved by spatial division or temporal division. In spatial division, each pixel PX specifically displays one primary color. In temporal division, each of the pixels PX displays different primary colors, the colors changing with time., Using either of these methods, primary colors are spatially or temporally synthesized to display a desired color. The primary colors may be, for example, red, green, and blue. As an example of the spatial division, FIG. 2 shows that each pixel PX has a color filter 230 for displaying one of the primary colors in a region of the upper panel 200 that will be aligned with the pixel electrode 191. Unlike in the structure shown in FIG. 2, the color filter 230 may be provided above or below the pixel electrode 191 of the lower panel 100.

At least one polarizer (not shown) for polarizing light is mounted on an outer surface of the liquid crystal panel assembly 300.

Referring to FIG. 1 again, the gray voltage generator 800 generates a plurality of gray voltage groups (or reference gray voltage groups) related to the transmittance of the pixel PX based on the digital gamma data DGD output from the signal controller 600. Some of the (reference) gray voltage groups have a positive value with respect to the common voltage Vcom, and the other gray voltage groups have a negative value with respect to the common voltage Vcom. The plurality of (reference) gray voltage groups may be independently provided to the pixels emitting light components having three primary colors, such as red, green, and blue. However, depending on the embodiment, the gray voltage generator 800 may generate one (reference) gray voltage group instead of three gray voltage groups. Alternatively, when four or more primary colors are used, the gray voltage generator 800 may generate four or more reference gray voltage groups.

When one pixel PX includes two sub-pixels, the gray voltage generator 800 may generate a plurality of (reference) gray voltage groups that are independently provided to the sub-pixels. In this case, the magnitude of one (reference) gray voltage group to be provided to one of the sub-pixels is larger than that of the (reference) gray voltage group to be provided to the other sub-pixel.

When the gray voltage generator 800 generates the reference gray voltage groups, a reference gray-scale may have 0, 32, 64, 96, 128, 160, 192, 224, or 255 levels. For each reference gray-scale level, the gray voltage generator 800 converts the digital gamma data DGD into analog data to generate the reference gray voltage group.

The gate driver 400 is connected to the gate lines G₁ to Gₙ of the liquid crystal panel assembly 300, and supplies gate signals, each composed of a combination of a gate-on voltage Von and a gate-off voltage Voff, to the gate lines G₁ to Gₙ.

The data driver 500 is connected to the data lines D₁ to Dₘ of the liquid crystal panel assembly 300, selects the gray voltage generated by the gray voltage generator 800, and supplies the selected gray voltage to the data lines D₁ to Dₘ as a data signal. However, when the gray voltage generator 800 does not supply all the gray voltages, but supplies only a predetermined number of reference gray voltages, the data driver 500 divides the reference gray voltage to generate gray voltages corresponding to all of the gray-scale levels, and selects the data signal from the generated gray voltages.

Alternatively, the data driver 500 may include a digital-to-analog converter (not shown) to convert a digital image signal to an analog data voltage. In this case, the data driver 500 may not receive the (reference) gray voltage groups from the gray voltage generator 800, which makes it unnecessary for the liquid crystal display 1000 to include the gray voltage generator 800.

The common voltage generator 700 generates the common voltage Vcom based on a digital common voltage data DVC output from the signal controller 600 and supplies the common voltage Vcom to the liquid crystal panel assembly 300. The digital common voltage data DVC has, for example, a 7-bit data value, and the common voltage generator 700 generates the common voltage Vcom having a one-to-one correspondence to the digital common voltage data DVC. It is preferable that the common voltage Vcom linearly correspond to the digital common voltage data DVC.

The storage unit 900 includes a non-volatile memory, and stores digital driving data related to the driving of the liquid crystal display 1000, such as the digital gamma data DGD, the digital common voltage data DVC, and reference correction image data. The storage unit 900 may store various information items of the liquid crystal display 1000, such as resolution, a frequency driving method, and an inverting method. The non-volatile memory includes, for example, a random access memory (RAM), an electrically erasable and programmable read only memory (EEPROM), and a flash memory.

The signal controller 600 controls, for example, the gate driver 400, the data driver 500, the common voltage generator 700, the gray voltage generator 800, and the storage unit 900.

Each of the drivers 400, 500, 600, 700, 800, and 900 may be directly mounted on the liquid crystal panel assembly 300 in the form of at least one IC chip, may be mounted on a flexible printed circuit film (not shown) and then mounted on the liquid crystal panel assembly 300 in the form of a TCP (tape carrier package), or may be mounted on a separate printed circuit board (PCB) (not shown). Alternatively, the drivers 400, 500, 600, 700, 800, and 900 may be integrated with the liquid crystal panel assembly 300 together with, for example, the signal lines G₁ to Gₙ and D₁ to Dₘ and the switching elements Q. The drivers 400, 500, 600, 700, 800, and 900 may be integrated into a single chip. In this case, at least one of the drivers or at least one circuit forming the drivers may be arranged outside the single chip.

Referring to FIG. 3, the storage unit 900, the signal controller 600, the common voltage generator 700, and the gray voltage generator 800 are connected to the serial bus 10, and communicate with one another through the serial bus 10.

For example, the serial bus 10 is composed of an I²C (inter integrated circuit) bus. The I²C bus includes two bi-directional communication lines 11 and 12, that is, a data line 11 that is referred to as an “SDA” and transmits serial data, addresses, and control bits, and a clock line 12 that is referred to as an “SCL” and transmits control and synchronizing clock signals.

The signal controller 600 serves as a master unit that creates a clock signal, transmits the clock signal to the clock line 12, and communicates with the storage unit 900, the common voltage generator 700, and the gray voltage generator 800 to transmit data. The storage unit 900, the common voltage generator 700, and the gray voltage generator 800 are identified by their specific addresses, and serve as slave units that transmit or receive data in response to a call of the signal controller 600.

Driving circuits, such as a temperature detecting circuit (not shown), a backlight control circuit (not shown), and a power generating unit (not shown), may be further connected to the serial bus 10 of the liquid crystal display 1000. An external apparatus (not shown) may be connected to the serial bus 10, and the external apparatus may serve as the master unit prior to the signal controller 600.

The serial bus 10 is not limited to the I²C bus. For example, the serial bus 10 may be composed of various members, such as a universal serial bus (USB), a serial peripheral interface, and recommended standard-232C (RS-232C).

Next, the operation of the liquid crystal display 1000 will be described in detail.

When power is supplied to the liquid crystal display 1000, the signal controller 600 reads out the digital common voltage data DVC and the digital gamma data DGD from the storage unit 900 through the serial bus 10, and respectively transmits these data DVC and DGD to the common voltage generator 700 and the gray voltage generator 800 to initialize the common voltage generator 700 and the gray voltage generator 800. The signal controller 600 also reads out the reference correction image data and control information and stores the read data in a separate storage unit (not shown) or a register (not shown).

The signal controller 600 receives input image signals R, G, and B and input control signals for displaying the input image signals R, G, and B from a graphic controller (not shown). The input image signals R, G, and B include luminance information of each pixel PX, and the luminance has a predetermined gray-scale level, for example, 1024 (=210), 256 (=28) or 64 (=26) gray-scale levels. For example, any of the following signals may be used as the input control signal: a vertical synchronization signal Vsync, a horizontal synchronization signal Hsync, a main clock MCLK, and a data enable signal DE.

The signal controller 600 processes the input image signals R, G, and B to make them suitable for the operational conditions of the liquid crystal panel assembly 300 and the data driver 500 based on the input control signal, and generates, for example, a gate control signal CONT1 and a data control signal CONT2. Then, the signal controller 600 transmits the gate control signal CONT1 to the gate driver 400 and transmits the data control signal CONT2 and the processed image signal DAT to the data driver 500.

The gate control signal CONT1 includes a scanning start signal STV indicating the start of scanning and at least one clock signal for controlling the output cycle of the gate-on voltage Von. The gate control signal CONT1 may further include an output enable signal OE defining the duration of the gate-on voltage Von.

The data control signal CONT2 includes a horizontal synchronization start signal STH indicating the start of the transmission of data to a row of pixels PX, a load signal LOAD allowing data signals to be transmitted to the data lines D₁ to Dₘ , and a data clock signal HCLK. The data control signal CONT2 may further include an inversion signal RVS for inverting the polarity of a data signal voltage with respect to the common voltage Vcom (hereinafter, “the polarity of a data signal voltage with the common voltage” is simply referred to as “the polarity of a data signal”).

The data driver 500 receives the digital image signal DAT for a row of pixels PX in response to the data control signal CONT2 transmitted from the signal controller 600, selects a gray voltage corresponding to each digital image signal DAT, converts the digital image signal DAT into an analog data signal, and supplies the analog data signal to the corresponding data lines D₁ to Dₘ.

Meanwhile, when the data driver 500 converts the digital image signal DAT from the signal controller 600 into an analog data signal without receiving the (reference) gray voltage group from the gray voltage generator 800, the signal controller 600 reads out information on a gamma curve from the storage unit 900 and generates the digital image signal DAT based on the read information.

The gate driver 400 applies the gate-on voltage Von to the gate lines G₁ to Gₙ based on the gate control signal CONT1 from the signal controller 600 to turn on the switching elements Q connected to the gate lines G₁ to Gₙ. Then, the data signals applied to the data lines D₁ to Dₘ are supplied to the corresponding pixels PX through the switching elements Q that are in an on state.

The difference between the voltage of the data signal applied to the pixel PX and the common voltage Vcom is a charging voltage of the liquid crystal capacitor Clc, that is, a pixel voltage. The alignment directions of liquid crystal molecules depend on the level of the pixel voltage, which determines the polarization of the liquid crystal layer 3. The variation in polarization causes a variation in the transmittance of light by the polarizer mounted on the liquid crystal panel assembly 300.

These processes are repeatedly performed for every one horizontal period [which is referred to as “1H” and is equal to one period of the horizontal synchronization signal Hsync and the data enable signal DE]. In this way, the gate-on voltage Von is sequentially applied to all the gate lines Gₗ, to Gₙ, and the data signals are supplied to all the pixels PX, thereby displaying one frame of images.

When one frame ends, the next frame starts. The state of the inversion signal RVS applied to the data driver 500 is controlled such that the polarity of the data signal voltage applied to each pixel PX is the reverse of the polarity of the data signal voltage in the previous frame (“frame inversion”). The polarity of the data signals applied to one data line may be inverted in the same frame according to the characteristic of the inversion signal RVS (for example, in the case of row inversion and dot inversion), or the polarities of the data signals applied to different rows of pixels may be different from each other (for example, column inversion and dot inversion).

Meanwhile, when a voltage is applied to both ends of the liquid crystal capacitor Clc, the liquid crystal molecules of the liquid crystal layer 3 tend to be rearranged in a stable state corresponding to the applied voltage. However, since the liquid crystal molecules have a low response speed, the liquid crystal molecules stabilize after a predetermined period of time elapses. When the voltage is applied to the liquid crystal capacitor Clc for a predetermined period of time, the liquid crystal molecules continue to move to reach a stable state. This movement causes a variation in light transmittance. When the liquid crystal molecules reach the stable state and stop moving, light transmittance becomes uniform.

The pixel voltage in the stable state is referred to as a target pixel voltage. The light transmittance at the target pixel voltage is referred to as a target light transmittance. In this case, a one-to-one correspondence is established between the target pixel voltage and the target light transmittance such that there is a set target light transmittance for a target pixel voltage.

However, since the length of time the switching element Q of each pixel PX can stay turned on is limited and the data voltage is applied during this limited length of time, it is difficult to stabilize the liquid crystal molecules while the data voltage is being applied. Even when the switching element Q is turned off, a voltage difference between the ends of the liquid crystal capacitor Clc occurs, causing the liquid crystal molecules to continue to move until they are stabilized. When the arrangement of the liquid crystal molecules changes, the dielectric constant of the liquid crystal layer 3 also changes, resulting in a variation in the capacitance of the liquid crystal capacitor Clc. When the switching element Q is in the off state, one terminal of the liquid crystal capacitor Clc is in a floating state. Therefore, when leakage current is not considered, the total charge stored in the liquid crystal capacitor Clc does not vary. The variation in the capacitance of the liquid crystal capacitor Clc causes a change in the voltage between the ends of the liquid crystal capacitor Clc, that is, a change in pixel voltage.

When a data voltage (hereinafter, referred to as a “target data voltage”) corresponding to the target pixel voltage based on the stable state is applied to the pixels PX, an actual pixel voltage differs from the pixel voltage, which makes it difficult to obtain the desired transmittance. In particular, the larger the difference between the desired transmittance and the initial transmittance of the pixel PX, the larger the difference between the pixel voltage and the target pixel voltage.

Therefore, the data voltage to be applied to the pixel PX needs to be smaller or larger than the target data voltage. This can be achieved by, for example, a dynamic capacitance compensation (DCC) method.

DCC is performed by the signal controller 600 or a separate image signal correcting unit. In DCC, an image signal corresponding to a frame that is to be supplied to a certain pixel PX [hereinafter, referred to as “current image signal g_{N}”] is corrected using an image signal corresponding to the previous frame supplied to the pixel [hereinafter, referred to as “previous image signal g_{N-1}”] to generate the corrected current image signal. In general, the corrected image signal is determined based on experimental results. The difference between the current image signal g_{N} and the previous image signal g_{N-1} after correction is generally larger than the difference between the current image signal g_{N} and the previous image signal g_{N-1} before correction. However, when the current image signal g_{N} is the same as the previous image signal g_{N-1} or when the difference therebetween is small, the corrected image signal may be the same as the image signal g_{N} (that is, the image signal may not be corrected).

In this way, the data voltage applied to each pixel PX by the data driver 500 becomes lower or higher than the target data voltage.

In order to correct the image signal, a storage space for storing the previous image signal g_{N-1} is used, and a frame memory (not shown) serves as the storage space. A lookup table (not shown) is used for storing the corrected image signal. The lookup table is large enough such that it can store the corrected image signals for all pairs of previous and current image signals (g_{N-1}, g_{N}). Therefore, it is preferable to store the corrected image signal as a reference correction image data g_{R}, for only the pair of previous and current image signals (g_{N-1}, g_{N}) having a size of, for example, 32 bits (see FIG. 19), and to calculate the corrected image signals by means of an interpolation method for the other pairs of previous and current image signals (g_{N-1}, g_{N}). According to the interpolation method for a pair of previous and current image signals (g_{N-1}, g_{N}), the reference correction image data g_{R} for a plurality of image signal pairs close to the pair of previous and current image signals (g_{N-1}, g_{N}) are searched, and the corrected image signals of the pair of previous and current image signals (g_{N-1}, g_{N}) are obtained using the reference correction image data g_{R}.

However, it may be difficult to obtain the desired transmittance by using this interpolation method. If so, an intermediate voltage is applied in the previous frame to incline the liquid crystal molecules [in what is referred to as a “pre-tilt process”], and a normal voltage is applied in the current frame.

In the process of the invention, the signal controller 600 or the image signal correcting unit corrects the image signals for the current frame in consideration of the image signals for the next frame [hereinafter, referred to as the “next image signal”] as well as the image signals for the previous frame. For example, when the current image signal g_{N} is the same as the previous image signal g_{N-1}, but the next image signal is considerably different from the current image signal g_{N}, the signal controller 600 or the image signal correcting unit corrects the image signal g_{N} in preparation for the next frame.

The correction of the image signal and the data voltage may or may not be performed on the image signal having the maximum or minimum gray-scale level. In order to correct the image signal having the maximum or minimum gray-scale level, the range of the gray voltage generated by the gray voltage generator 800 may be wider than the range of the target data voltage that is used to obtain a target luminance range (or a target transmittance range) represented by the gray-scale level of the image signal.

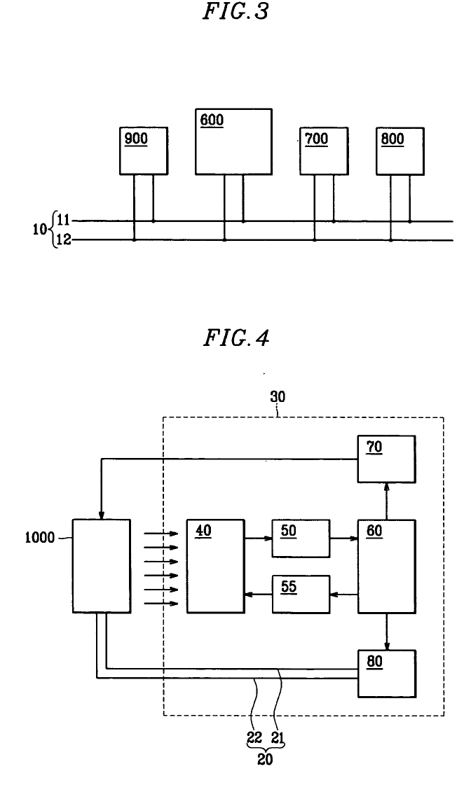

Next, a manufacturing apparatus and method according to an embodiment of the invention that optimizes the common voltage Vcom, the reference gray voltage, and the reference correction image data g_{R} of the liquid crystal display 1000 will be described in detail below with reference to FIGS. 4 to 7.

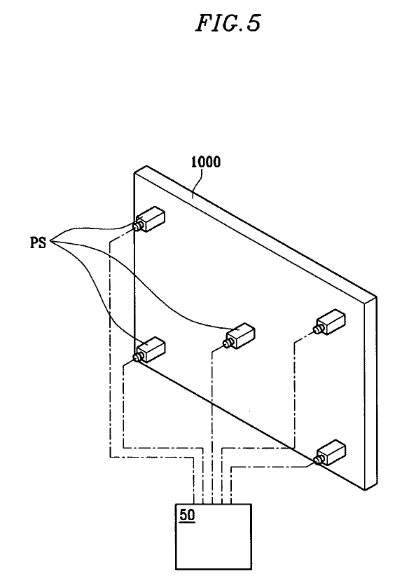

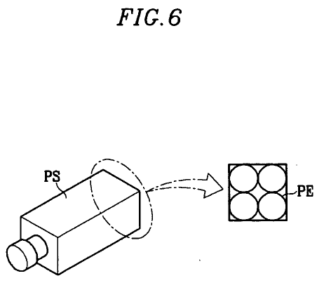

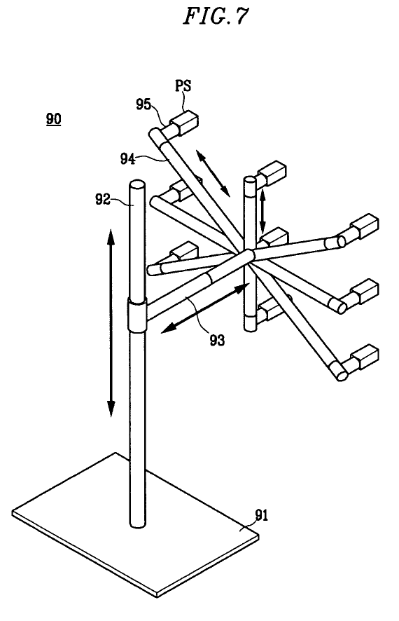

FIG. 4 is a block diagram illustrating a manufacturing apparatus according to an exemplary embodiment of the present invention, FIG. 5 is a schematic diagram illustrating an optical sensor module of a manufacturing apparatus according to an exemplary embodiment of the present invention, and FIG. 6 is a schematic diagram illustrating an optical sensor of the optical sensor module shown in FIG. 5. FIG. 7 is a schematic diagram illustrating a jig for supporting an optical sensor module according to an exemplary embodiment of the present invention.

As shown in FIG. 4, a manufacturing apparatus 30 according to an exemplary embodiment of the present invention includes an optical sensor module 40, a sensing signal processing unit 50, a module controller 55, a main processor 60, an image pattern creating unit 70, a serial bus controller 80, and a serial bus 20.

The optical sensor module 40 includes a plurality of optical sensors PS. When light from the liquid crystal display 1000 is incident on the optical sensor module 40, the optical sensor module 40 generates an analog sensing signal corresponding to the luminance of the liquid crystal display 1000 and transmits the analog sensing signal to the sensing signal processing unit 50. The optical sensors PS sense luminance at a plurality of positions on the screen of the liquid crystal display 1000, for example, at the center and four corners of the screen, as shown in FIG. 5. The number of optical sensors PS included in the optical sensor module 40 may be adjusted as fit, and the optical sensors may be arranged at different positions.

Especially due to the general increase in the size of the liquid crystal display 1000, the flicker levels at the center and the four corners of the screen may be different from each other. Using a plurality of optical sensors PS makes it possible to adjust the common voltage Vcom according to the flicker characteristics of the liquid crystal display 1000.

One optical sensor PS includes at least one sensing element PE. For example, in the embodiment of FIG. 6, one optical sensor PS includes four sensing elements PE. When the optical sensor PS includes a plurality of sensing elements PE, signals output from the sensing elements PE overlap each other, and the overlapping signals serve as a sensing signal from the one optical sensor PS. The sensing signal makes it possible to amplify the signal output from each sensing element PE to reduce the characteristic deviation of each sensing element PE and to raise a signal-to-noise ratio, thus allowing an accurate extraction of a sensing signal.

A different type of optical sensor (not shown) may be separately provided to correct the optical sensor PS.

Referring to FIG. 7, a manufacturing apparatus 30 according to an exemplary embodiment of the present invention includes a jig 90 for supporting the optical sensor module 40. The jig 90 includes a base 91, a vertical portion 92 extending substantially orthogonal to the base 91, a central horizontal portion 93 that is connected to the vertical portion 92, a plurality of branches 94 that are connected to one end of the central horizontal portion 93 so as to radially extend from the central axis of the central horizontal portion 93, and a plurality of end horizontal portions 95. The central horizontal portion 93 extends at a right angle from the vertical portion 92 and its length can be adjusted as shown by the two-headed arrow. The position of the central horizontal portion 93 is adjustable along the vertical portion 92. The end horizontal portions 95 are connected to the end of the central horizontal portion 93 and to the ends of the branches 94. The positions of the end horizontal portions 95 can be changed along the branches 94 as indicated by the two-headed arrows, and optical sensors PS are coupled to the end horizontal portions 95. Angles formed among the branches 94 may be adjusted.

The jig 90 makes it possible to adjust the positions of the optical sensors PS and thus to arrange the optical sensors PS at desired positions regardless of the size of the screen of the liquid crystal display 1000.

Various devices may be used as the jig 90. In particular, the jig 90 may be part of an industrial robot that is capable of automatically adjusting the positions of the optical sensors PS for optimal result.

The sensing signal processing unit 50 receives the analog sensing signal from an optical sensor module 40 and performs functions such as amplification, filtering, and analog-to-digital conversion on the received signal. The the digital sensing signal that is produced is transmitted to the main processor 60.

The module controller 55 controls the characteristics of each optical sensor PS of the optical sensor module 40. The plurality of optical sensors PS can output different sensing signals with respect to the same luminance. In this case, it is possible to reduce a deviation in the output sensing signals to a minimum by controlling the characteristics of the optical sensor PS.

The image pattern creating unit 70 creates a test image pattern to be displayed on the liquid crystal display 1000 and an input control signal of the liquid crystal display 1000, and transmits the test image pattern and the input control signal to the liquid crystal display 1000. The image pattern creating unit 70 generates a trigger signal such that the main processor 60 can recognize the point of time at which the frame changes, and transmits the trigger signal to the sensing signal processing unit 50 or the main processor 60. The trigger signal may be a vertical synchronization signal Vsync or a synchronization signal that is separately generated. In some embodiments, the trigger signal may not be used at all. Where the trigger signal is not used, a sensing signal with respect to a specific test image pattern may be analyzed to estimate a trigger time where the frame varies.

The main processor 60 controls the module controller 55, the image pattern creating unit 70, and the serial bus controller 80. The main processor 60 receives a digital sensing signal from the sensing signal processing unit 50, generates optimum digital driving data based on the digital sensing signal, and transmits the digital driving data to the serial bus controller 80.

The serial bus controller 80 receives the digital driving data from the main processor 60, converts the digital driving data into a suitable serial signal, and transmits the converted signal to the serial bus 20.

The serial bus 20 is composed of the same interface as the serial bus 10 of the liquid crystal display 1000. As described above, when the serial bus 10 is an I²C bus, the serial bus 20 also includes a data line 21 and a clock line 22. When the process of optimizing the digital driving data of the liquid crystal display 1000 starts, the two lines 21 and 22 are connected to the data line 11 and the clock line 12 of the liquid crystal display 1000, respectively. The serial bus controller 80 that is connected to the serial buses 10 and 20 serves as a master unit over the signal controller 600 of the liquid crystal display 1000. When the process of optimizing the digital driving data of the liquid crystal display 1000 is completed, the two serial buses 10 and 20 are separated.

Next, a method of manufacturing a liquid crystal display according to an exemplary embodiment of the present invention will be described in detail with reference to FIG. 8. FIG. 8 is a flowchart illustrating a method of manufacturing a liquid crystal display according to an exemplary embodiment of the present invention.

First, when a process of optimizing the digital driving data of the liquid crystal display 1000 starts, the liquid crystal display 1000 is loaded on a test table (not shown) (S100).

Then, the serial bus 20 of the manufacturing apparatus 30 is connected to the serial bus 10 of the liquid crystal display 1000 (S200).

The manufacturing apparatus 30 detects the flicker level of the liquid crystal display 1000, and changes the digital common voltage data DVC such that the flicker level is reduced to the minimum level, thereby adjusting the common voltage Vcom (S300).

Then, the manufacturing apparatus 30 adjusts the digital gamma data DGD such that the gray voltage of the liquid crystal display 1000 has a desired gamma characteristic, thereby setting the gray voltage (S400).

Subsequently, the manufacturing apparatus 30 detects a variation in the luminance of the liquid crystal display 1000 due to a change in the image data, and generates the reference correction image data g_{R} through a predetermined process (S500).

When the adjustment and generation of the digital driving data for the liquid crystal display 1000 are completed, the manufacturing apparatus 30 stores the history of the liquid crystal display 1000 in a separate storage space (S600), and disconnects the serial bus 20 from the serial bus 10 of the liquid crystal display 1000 (S700).

Then, the liquid crystal display 1000 is separated from the test table (S800).

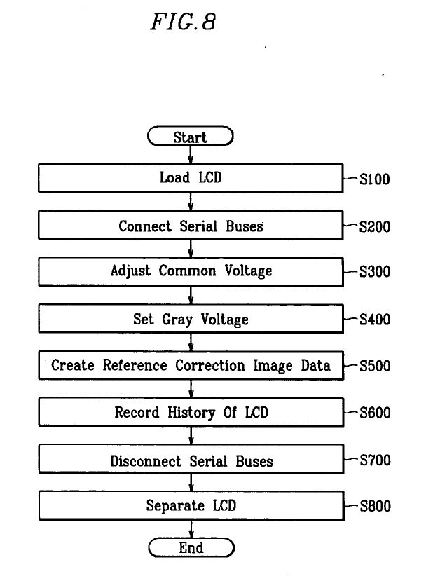

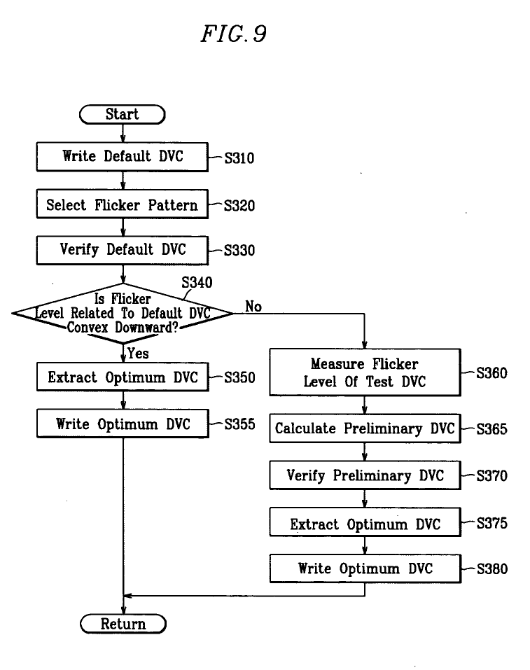

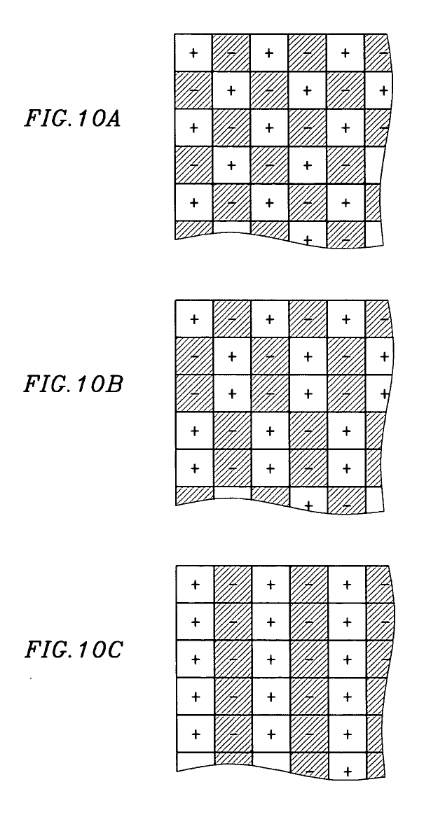

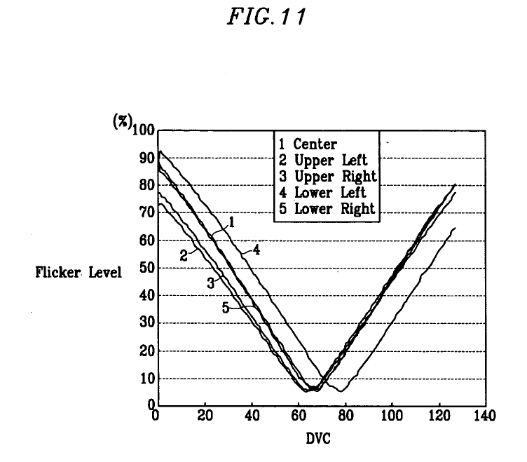

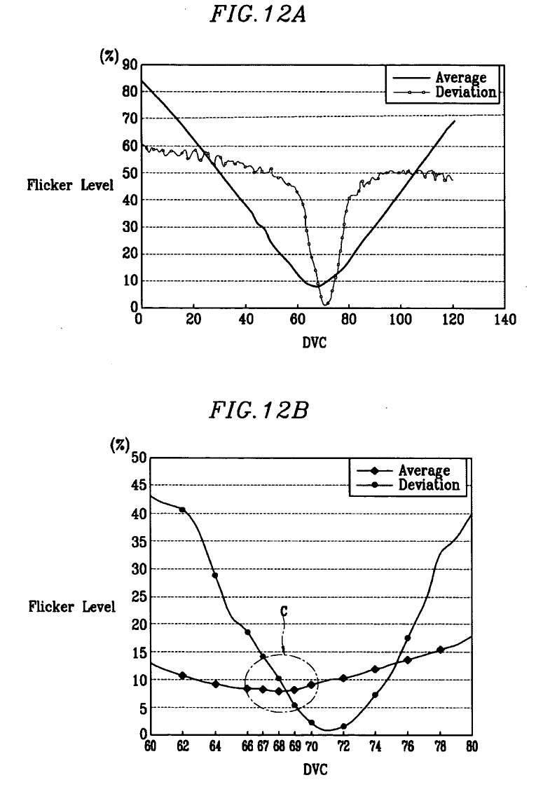

Next, a method of adjusting the common voltage of the liquid crystal display 1000 according to an exemplary embodiment of the present invention will e described in detail with reference to FIGS. 9 to 12B. FIG. 9 is a flowchart illustrating a method of adjusting the common voltage of a liquid crystal display according to an exemplary embodiment of the present invention, and FIGS. 10A to 10C are schematic diagrams illustrating a flicker pattern for adjusting the common voltage of the liquid crystal display. FIG. 11 is a graph illustrating the flicker level of digital common voltage data. FIGS. 12A and 12B are examples of the graph shown in FIG. 11 and are graphs illustrating a method of extracting optimum digital common voltage data in consideration of the average flicker level and deviation.

As shown in FIG. 9, when a process of adjusting the common voltage starts, the manufacturing apparatus 30 writes predetermined default digital common voltage data (default DVC) onto the common voltage generator 700 of the liquid crystal display 1000 through the serial buses 10 and 20 (S310). The default DVC is the digital common voltage data DVC for generating an initial common voltage of the liquid crystal display 1000 selected at the time of research and development. The default DVC may be stored in the manufacturing apparatus 30, or the manufacturing apparatus 30 may read out the default DVC from the storage unit 900 of the liquid crystal display 1000.

Then, the manufacturing apparatus 30 displays a predetermined flicker pattern, detects the luminance, and selects a flicker pattern suitable for adjusting the common voltage Vcom of the liquid crystal display 1000 (S320).

The liquid crystal display 1000 has inversion modes, such as a dot inversion mode where the polarity of the data voltage is inverted for every pixel, a two-by-one inversion mode where the polarity of the data voltage is inverted for every two-by-one pixels, and a column inversion mode where the polarity of the data voltage is inverted for every column of pixels. In the flicker pattern, an intermediate gray-scale and a black gray-scale alternately appear in the units of pixels used in the inversion mode. The flicker pattern includes a dot flicker pattern where the gray-scale is changed for every pixel (see FIG. 10A), a two-by-one flicker pattern where the gray-scale is changed for every two-by-one pixels (see FIG. 10B), and a column flicker pattern where the gray-scale is changed for every column of pixels (see FIG. 10C). When the inversion mode and the flicker pattern of the liquid crystal display 1000 match, the flicker level rises higher than in a case where the inversion mode does not match the flicker pattern. Therefore, in order to select the flicker pattern that is suitable for the inversion mode of the liquid crystal display 1000, the manufacturing apparatus sequentially displays the flicker patterns, detects the luminance, and selects the flicker pattern having the highest luminance.

The flicker level, which is a standard for the adjustment of the common voltage Vcom, can be quantified by the following Equation 1:

$$\begin{matrix}flicker level = alternating current component / \\ direct current component ( \% ) \\ = ( V max - V min ) / \{ ( V max + V min ) / 2 \} * \\ 100 [ \% ]\end{matrix} \qquad ( Equation 1 )$$

where Vmax indicates the maximum value of the sensing signal obtained by one optical sensor while the flicker pattern is being displayed, and Vmin indicates the minimum value of the sensing signal obtained by one optical sensor PS.

As shown in Equation 1, the amount of flicker is defined by the ratio of the alternating current component to the direct current component (%). The alternating current component is the difference between the maximum value and the minimum value, and the direct current component is the average value of the maximum value and the minimum value.

When information on the inversion mode is stored in the storage unit 900 of the liquid crystal display 1000, step S320 may be omitted. In this case, the manufacturing apparatus 30 reads the information from the storage unit 900 and displays a flicker pattern corresponding to the information.

Then, the manufacturing apparatus 30 verifies the default DVC while displaying the flicker pattern (S330). For example, as shown in FIG. 5, when the optical sensor PS measures the luminance of the liquid crystal display 1000 at the center, the upper left side, the upper right side, the lower left side and the lower right side of the screen, the manufacturing apparatus 30 detects the flicker level of the default DVC, and calculates the average flicker level and deviation. Then, the manufacturing apparatus writes in the common voltage generator 700 values obtained by adding to or subtracting from the devault DVC a value between 1 and M, detects the average flicker level of each of the values, and calculates the deviation (M>2).

As shown in FIG. 11, five flicker levels for the digital common voltage data DVC may be different from each other. Therefore, it is preferable that the average value of the five flicker levels be used as a representative value. The deviation is the difference between two of the five flicker levels having the maximum and minimum values. For example, the average flicker level and the deviation are shown in FIGS. 12A and 12B. FIG. 12B is a partial, enlarged drawing of FIG. 12A.

Then, the average value of 2M+1 flicker levels is calculated, and it is determined whether a curved line obtained by connecting these flicker levels has a dip in the center (S340).

Referring to FIGS. 11 to 12B, the flicker level is lowered as the digital common voltage data DVC approaches a certain value and then rises again as the digital common voltage data DVC increases beyond this value. Therefore, the curved line obtained by connecting the flicker levels has an approximately U-shape with a minimum. Step S340 determines whether the curved line obtained by connecting 2M+1 average flicker levels has a minimum. Accordingly, one of the digital common voltage data DVC having the smallest deviation corresponding to the maximum and minimum levels of 2M+1 average flicker levels is extracted as an optimum DVC (S350). For example, as represented by a character “C” in FIG. 12B, when the digital common voltage data DVC is in the range of 66 to 70, the flicker level has the minimum value. Therefore, when 70, having the smallest deviation, is selected from the digital common voltage data DVC as the optimum DVC, the flicker level of the entire liquid crystal display 1000 is lowered and the deviation of each part of the screen is also reduced.

Then, the extracted optimum DVC is written in the storage unit 900 of the liquid crystal display 1000 (S355) and the process is ready to be repeated when desired.

When step S340 determines that the curved line does not have a minimum, the flicker level of a test DVC is measured (S360). The test DVC indicates a group of digital common voltage data DVC in a predetermined number of units, such as 8 or 16 units. Therefore, when the digital common voltage data DVC is a 7-bit data, the test DVC has value of 0, 7, 15, . . . , 119, 127 or 0, 15, . . . , 111, 127. The manufacturing apparatus 30 writes each of the values in the common voltage generator 700, detects the flicker level, and calculates the average flicker level and the deviation.

Then, the manufacturing apparatus 30 calculates a preliminary DVC based on the average flicker level for the test DVC (S365). The preliminary DVC can be calculated as follows. First, a minimum value y₁ of the average flicker levels for the test DVC and a test DVC x₁ corresponding thereto are found. Then, coefficients of the following quadratic Equation 2 are calculated using the average flicker levels y₂ and y₃ for a value x₂ that is larger than the value x₁ by one unit and a value x₃ that is smaller than the value x₁ by one unit.
y=ax²+bx+c (Equation 2)

That is, values (x₁, y₁), (x₂, y₂), and (x₃, y₃) are substituted to Equation 2, and Cramer's rule is used to calculate coefficients a, b, and c. Then, −b/2a is calculated, and the digital common voltage data DVC closest to the calculated value is found as the preliminary DVC.

Next, the preliminary DVC is verified (S370). Step S370 is similar to step S330 of verifying the default DVC. That is, the manufacturing apparatus 30 writes in the common voltage generator 700 values obtained by adding to or subtracting from the preliminary default DVC a value between 1 and N, detects the average flicker level of each of the values, and calculates the deviation (N>2).

Unlike the default DVC, in the case of the preliminary DVC, a curved line obtained by connecting 2N+1 average flicker levels has a minimum. Therefore, similarly to step S350, one of the digital common voltage data DVC having the smallest deviation corresponding to the maximum and minimum levels of 2N+1 average flicker levels is extracted as an optimum DVC (S375).

Then, the extracted optimum DVC is stored in the storage unit 900 of the liquid crystal display 1000 and the process is ready to be repeated when desired (S380).

As described above, with the method of adjusting the common voltage according to an exemplary embodiment of the present invention, a plurality of optical sensors are used to automatically adjust the common voltage. This method makes it possible to select the common voltage that is most suitable for the liquid crystal display and to shorten the time required to manufacture the liquid crystal display.

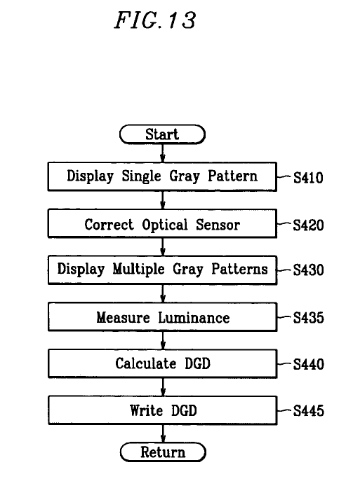

Next, a method of setting a gray voltage of the liquid crystal display 1000 according to an exemplary embodiment of the present invention will be described in detail with reference to FIGS. 13 to 15B.

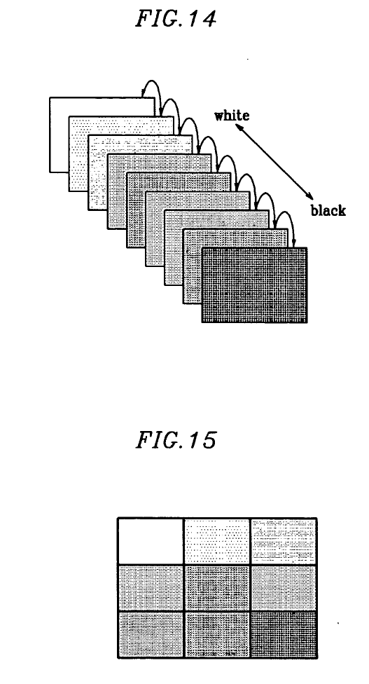

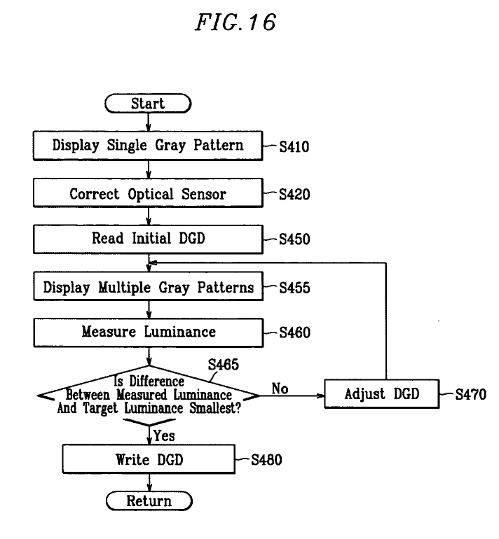

FIG. 13 is a flowchart illustrating a method of setting a gray voltage according to an exemplary embodiment of the present invention, FIG. 14 shows an example of a test image pattern for correcting an optical sensor module according to an exemplary embodiment of the present invention, and FIG. 15 shows an example of a test image pattern for obtaining V-T characteristics of a liquid crystal display.

As shown in FIG. 13, when a process of setting a gray voltage starts, the image pattern creating unit 70 transmits an image signal and a control signal to the liquid crystal display 1000, and displays a single gray pattern (S410) such that uniform luminance is displayed on the screen. The optical sensor PS measures the luminance and transmits the measured luminance to the main processor 60. As shown in FIG. 14, the single gray pattern is changed from a white gray-scale to a black gray-scale or from the black gray-scale to the white gray-scale at a predetermined gray-scale level interval, and the luminance of the changed single gray-scale is measured.

When a signal gray-scale is displayed, the luminance of the entire screen of the liquid crystal display 1000 is uniform, but the optical sensors PS measuring the luminance at different spots on the display may output different signals. Therefore, in order to match the output signals, the main processor 60 corrects the optical sensors PS using the stored sensing signals of the optical sensors PS (S420).

The module controller 55 may adjust the output signal or sensitivity of the optical sensor PS to correct the optical sensor PS. The main processor 60 may receive a digital sensing signal and perform predetermined processing on the received signal to correct the optical sensor PS. However, when a high-accuracy optical sensor is provided, the high-accuracy optical sensor may be used to correct the optical sensor PS prior to the process of setting a gray voltage.

The optical sensor PS does not have to be corrected every time the gray voltage of a liquid crystal display 1000 is set for manufacturing. For example, the optical sensor PS may be corrected every predetermined number of times the gray voltage is set or when a given period of time elapses. Steps S410 and S420 may be executed only when the optical sensor PS is corrected.

Then, the image pattern creating unit 70 transmits an image signal and a control signal to the liquid crystal display 1000, and displays multiple gray patterns as shown in FIG. 15 (S430) such that light components having different luminance are emitted from the regions where the optical sensors PS are positioned. Then, the optical sensors PS measure the luminance (S435). The main processor 60 stores the measured luminance information. Then, steps S430 and S435 are repeatedly performed while changing the gray-scale level.

The initial gray voltage of the liquid crystal display 1000 may be input to the manufacturing apparatus 30 before the image pattern creating unit 70 transmits signals to the liquid crystal display 1000. Alternatively, the main processor 60 may read out initial digital gamma data from the gray voltage generator 800 to know the relationship between the gray-scale and the gray voltage. In steps S430 and S435, the main processor 60 measures the luminance of the multiple gray-scales to know the gray-scale levels and the luminance levels corresponding to the gray-scale levels. Therefore, the main processor 60 knows the voltage that is applied to the liquid crystal display and a transmittance (V-T characteristic) corresponding to the voltage. The main processor 60 determines the gray voltage to be set in order to obtain a desired gamma curve based on the voltage and the transmittance. The main processor 60 can convert the determined gray voltage into a digital value to the optimum digital gamma data DGD (S440). In this case, the luminance has a one-to-one correspondence to the transmittance, and a gamma curve is defined by the relationship between the gray-scale and the transmittance.

The obtained digital gamma data DGD is stored in the storage unit 900 (S445), and the process is ready to be repeated when desired.

In the multiple gray patterns of the example, the number of gray-scales is 9. However, a person of ordinary skill in the art would understand that this is not a limitation of the invention and the number of gray-scales depends on the number of optical sensors PS.

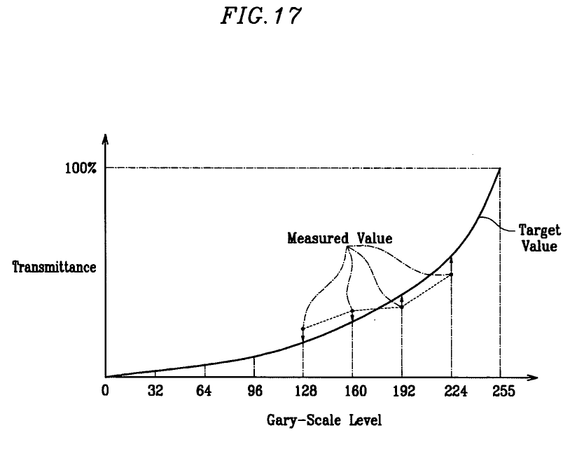

Next, a method of setting a gray voltage according to another exemplary embodiment of the present invention will be described in detail with reference to FIGS. 16 and 17.

FIG. 16 is a flowchart illustrating a method of setting a gray voltage according to another exemplary embodiment of the present invention, and FIG. 17 is a schematic diagram illustrating the method of setting a gray voltage shown in FIG. 16.

As shown in FIG. 16, when a process of setting a gray voltage starts, a single gray pattern is displayed (S410), and the optical sensor PS is corrected (S420), similar to the above-mentioned embodiment.

The main processor 60 reads out initial digital gamma data DGD from the gray voltage generator 800 through the serial buses 10 and 20 (S450).

Then, the main processor 60 displays multiple gray patterns shown in FIG. 15 (S455), and measures luminance (S460). In this case, preferably, in the multiple gray patterns, a gray-scale is a reference gray-scale capable of generating a reference gray voltage. For example, the reference gray-scale has 0, 32, 64, . . . , 255 levels.

The main processor 60 determines whether the difference between the measured luminance and a target luminance is smallest (S465).

The main processor 60 measures the luminance of the highest gray-scale level, and makes the measured luminance completely correspond to the transmittance of a gamma curve, thereby knowing a target luminance corresponding to each reference gray-scale from the gamma curve. The main processor 60 investigates the difference between the target luminance and the luminance measured for each reference gray-scale, and adjusts the digital gamma data DGD until the measured luminance is closest to the target luminance (S470). Referring to FIG. 17, when the measured luminance is higher than the target luminance, such as at 128 or 160 gray-scale levels, the corresponding gray voltage is lowered (the gray voltage may rise according to the mode of the liquid crystal display). When the measured luminance is lower than the target luminance, such as at 192 and 224 gray-scale levels, the corresponding gray voltage rises (the gray voltage may be lowered according to the mode of the liquid crystal display). In this way, the luminance measured at the corresponding gray-scale level can be approximate to the target luminance.

When the digital gamma data DGD where the difference between the target luminance and the luminance measured for all the gray-scale levels is smallest is obtained, the obtained digital gamma data DGD is stored in the storage unit 900 (S480), and the process is returned.

Meanwhile, when the signal controller 600 uses information on the gamma curve to generate the digital image signal DAT, without using the gray voltage generator 800, the manufacturing apparatus 30 may change the information on the gamma curve instead of the digital gamma data DGD to set the gray voltage. Since this gray voltage setting method is substantially similar to the above-mentioned examples, a detailed description thereof will be omitted.

As described above, according to the method of setting a gray voltage according to an exemplary embodiment of the present invention, a plurality of optical sensors is used to automatically adjust the gray voltage. This method makes it possible to select a gray voltage that is most suitable for each liquid crystal display and to shorten the time required to manufacture the liquid crystal display.

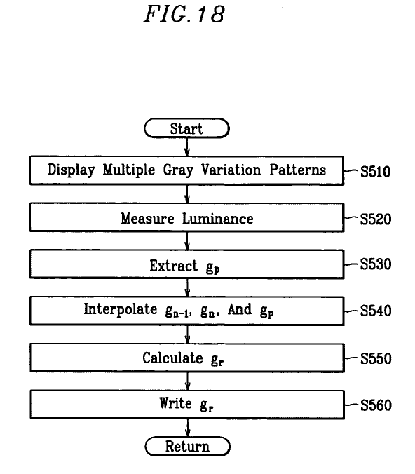

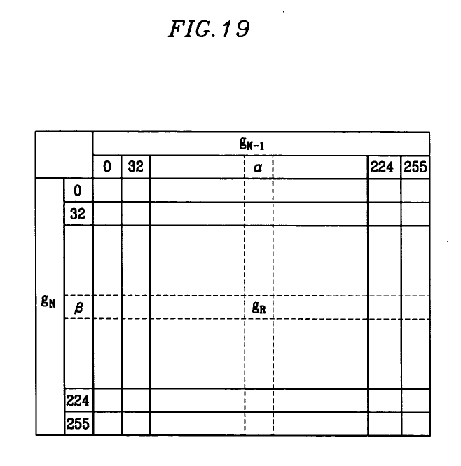

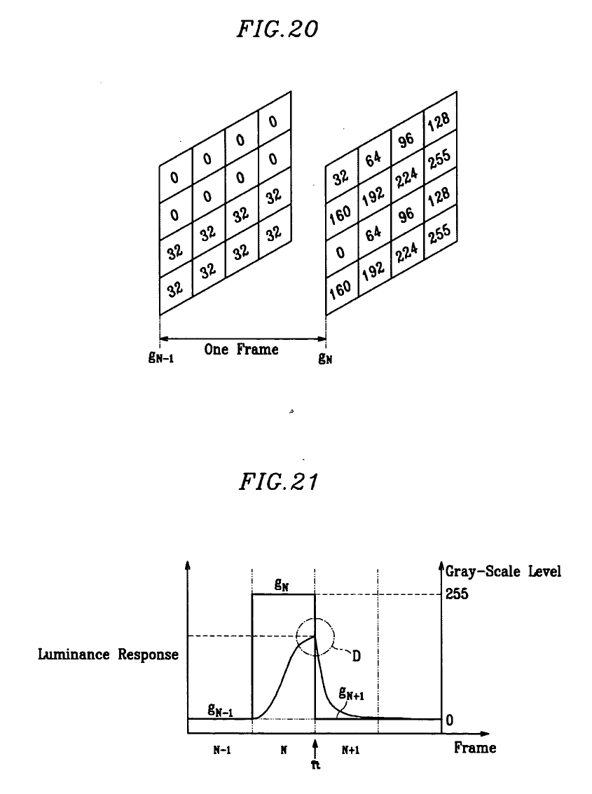

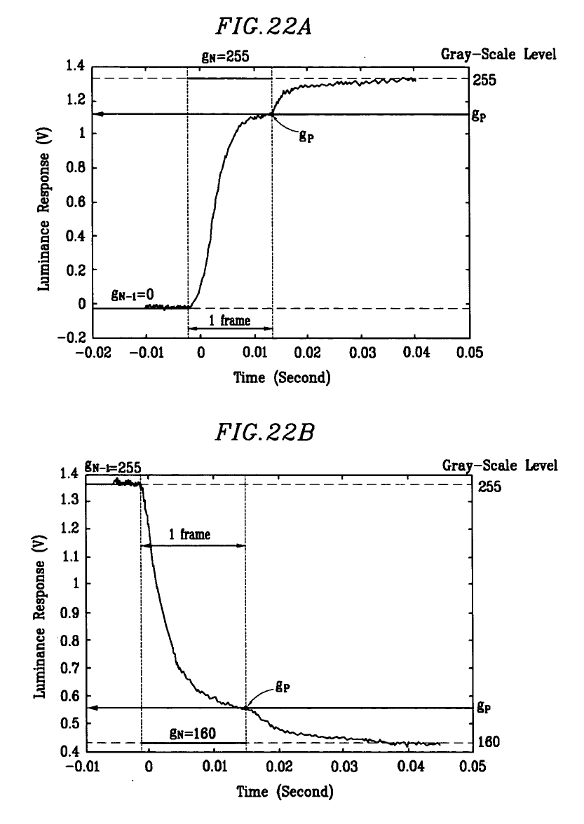

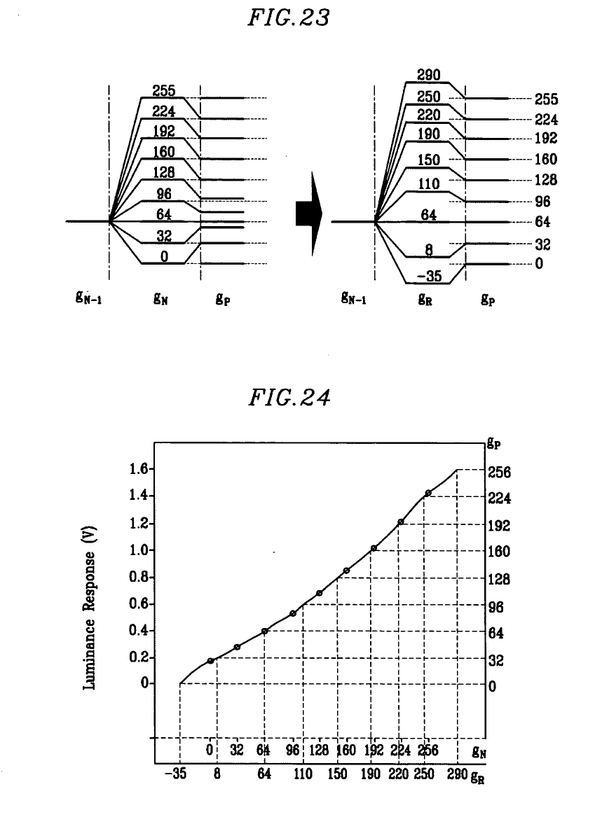

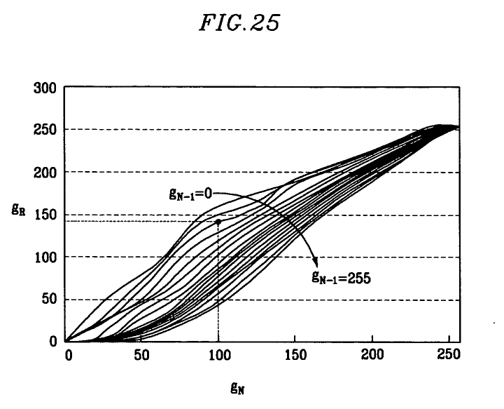

Next, a method of setting reference correction image data of the liquid crystal display 1000 according to an exemplary embodiment of the present invention will be described in detail with reference to FIGS. 18 to 25. FIG. 18 is a flowchart illustrating a method of setting reference correction image data according to an exemplary embodiment of the present invention, and FIG. 19 is a schematic diagram illustrating the structure of a lookup table having the reference correction image data stored therein. FIG. 20 shows an example of a test image pattern for obtaining the reference correction image data according to an exemplary embodiment of the present invention, FIG. 21 is a schematic diagram illustrating a data signal for extracting a frame start point and a luminance response to the data signal, and FIGS. 22A and 22B are waveform diagrams illustrating a luminance response when the data signal varies. FIG. 23 is a diagram illustrating a principle of obtaining reference correction image data by means of interpolation according to an exemplary embodiment of the present invention, FIG. 24 is a diagram illustrating a method of obtaining reference correction image data by interpolating data extracted by an exemplary embodiment of the present invention, and FIG. 25 is a diagram illustrating reference correction image data obtained by an exemplary embodiment of the present invention.

For better comprehension and ease of description, the previous image signal g_{N-1} is referred to as a previous gray-scale, and the current image signal g_{N} is referred to as a target gray-scale.

As shown in FIG. 18, when a process of creating reference correction image data starts, the image pattern creating unit 70 transmits an image signal and a control signal to the liquid crystal display 1000, and displays a multiple gray-scale variation pattern shown in FIG. 20 (S510). Then, the optical sensor PS measures the luminance due to a variation in gray-scale (S520).

The multiple gray-scale variation pattern is obtained by variation from a plurality of previous gray-scales g_{N-1} to a plurality of target gray-scales g_{N}. In this case, each of the previous gray-scale g_{N-1} and the target gray-scale g_{N} may have, for example, 0, 32, . . . , 224, 255 levels referring to the reference correction image data g_{R} on the lookup table shown in FIG. 19 The gray-scale levels may be changed if necessary. Therefore, in the case of FIG. 19, nine-by-eight combinations of the previous gray-scale g_{N-1} and the target gray-scale g_{N} are obtained when the two gray-scales have the same gray-scale level. When the number of optical sensors PS is 16, as shown in FIG. 20, the screen of the liquid crystal display 1000 may be divided into 16 regions. Therefore, one multiple gray variation pattern can display 16 combinations of the previous gray-scale g_{N-1} and the target gray-scale g_{N}. For example, combinations of the target gray-scales g_{N} having “32, 64, . . . , 255” levels and the previous gray-scales g_{N-1} having a “0” level and combinations of the target gray-scales g_{N} having “0, 64, . . . , 255” levels and the previous gray-scales g_{N-1} having “32” levels can be displayed on one screen as a multiple gray variation pattern. Therefore, 5 multiple gray variation patterns can display a gray-scale variation for all the combinations.

The point of time when one frame is changed is accurately checked in order to detect a variation in luminance due to a change in gray-scale. As described above, in order to check the point of time, the image pattern creating unit 70 may transmit a trigger signal to the main processor 60 in synchronization with the change in gray-scale. However, when the trigger signal is not used, it is possible to estimate a trigger time when one frame is changed by displaying a specific test image pattern and by analyzing a luminance response waveform. As shown in FIG. 21, for example, when the gray-scale level is changed in the unit of one frame in the order of a low gray-scale level→a high gray-scale level→a low gray-scale level, such as in the order of 0 level→255 levels→0 level, the luminance response waveform has a peak point at the time when the gray-scale is changed from a high level to a low level, as represented by a character “D”. The time Tt corresponding to the peak point is a trigger time when the frame is changed. Then, the time elapsed from the trigger time is measured to grasp a point of time when the luminance is changed due to a variation in multiple gray-scales. In this embodiment, 0 and 255 gray-scale levels are just illustrative examples, but the gray-scale levels may be changed according to the multiple gray variation pattern.

FIG. 22A shows the luminance response waveform when the previous gray-scale g_{N-1} has a “0” level and the target gray-scale g_{N} has “255” levels. FIG. 22B shows the luminance response waveform when the previous gray-scale g_{N -1} has “255” levels and the target gray-scale g_{N} has “160” levels. When the gray-scale varies in this way, as shown in FIGS. 22A and 22B, a luminance corresponding to the target gray-scale g_{N} is not obtained at a point of time when one frame is changed (when a vertical synchronization frequency is 60Hz, 16.67ms) due to a low response speed of liquid crystal. At that time, the luminance displayed by the liquid crystal corresponds to a response gray-scale g_{P}.

The measured luminance response waveform is converted into digital data, and filtering and average calculation are performed on the digital data. Then, the luminance level at a point of time after one frame from a point of time when the target gray-scale g_{N} is obtained is extracted, and the response gray-scale g_{P} corresponding to the extracted luminance level is extracted (S530). The measured luminance level is a voltage value, and the response gray-scale g_{P} has a one-to-one correspondence to the voltage value. The previous gray-scale g_{N-1} and the target gray-scale g_{N} may be extracted from the luminance response waveform, if desired.

When the response gray-scales g_{P} for all the combinations of the previous gray-scales g_{N-1} and the target gray-scales g_{N} are extracted, interpolation is performed on the previous gray-scales g_{N-1}, the target gray-scales g_{N} and the response gray-scales g_{P} (S540). Then, the reference correction image data g_{R} is calculated (S550).

Any of the following methods can be used for the interpolation: a nearest neighbor interpolation method, a linear interpolation method, a piecewise cubic spline interpolation method, and a piecewise cubic Hermite interpolation method.

The response gray-scales g_{P} extracted when the gray-scale is changed from the previous gray-scale g_{N-1} having “64” to the target gray-scales g_{N} having 0, 32, 96, . . . , 255 levels is shown on the lefthand side of FIG. 23. Since the response gray-scale g_{P} does not reach the target gray-scale g_{N} due to a low response speed of the liquid crystal, a region where the response gray-scales g_{P} are distributed is narrower than a region where the target gray-scales g_{N} are distributed. In addition, the levels of the response gray-scales g_{P} are not distributed at regular intervals. When the levels of the response gray-scales g_{P} are adjusted at regular intervals by interpolation, as shown on the righthand side of FIG. 23, the levels of the target gray-scales g_{N} are also adjusted. As a result, the adjusted levels are the reference correction image data g_{R} . For example, in order to change a luminance corresponding to the gray-scale g_{N-1} having 64 levels to a luminance corresponding to the gray-scale g_{P} having 160 levels, the gray-scale g_{N-1} having 64 levels should be changed to the gray-scale g_{N} having 190 levels.

More specifically, as shown in FIG. 24, the correspondences between the extracted target gray-scales g_{N} and the response gray-scales g_{P} are represented by points (which are represented by small circles) on a graph. Then, interpolation is performed on the graph to produce the luminance response curve as shown in FIG. 24. In the graph shown in FIG. 24, the right vertical axis is graduated in 32 gray-scale levels, and horizontal lines are drawn so as to correspond to the graduations. Gray-scale values “−35, 8, 64, . . . , 250, 290” on the horizontal axis corresponding to intersections of the horizontal lines and the luminance response curve are the reference correction image data g_{R} . However, since the gray-scale level represented by 8 bits is in the range of 0 to 255 levels, values beyond the range are replaced with “0” or “255”. In the graph, the left vertical axis indicates the luminance response as a voltage value, and the voltage values are relative values that can be changed according to a measuring device. The right vertical axis indicates the response gray-scale g_{P} corresponding to the luminance response, and the horizontal axis indicates the target gray-scale g_{N} and the calculated reference correction image data g_{R}.

In this way, the reference correction image data g_{R} for all the previous gray-scales g_{N-1} is calculated. Then, it is possible to calculate the reference correction image data g_{R} corresponding to a 9×9 lookup table. The interpolation can be performed one more time on the previous gray-scales g_{N-1}, the target gray-scales g_{N}, and the calculated reference correction image data g_{R} to calculate the reference correction image data g_{R} corresponding to a 17×17 lookup table. Although the interpolation is performed two times in the example provided herein, this is not a limitation of the invention. For example, the interpolation may be performed just once or more than twice. The size of the lookup table may be set as desired, and the reference correction image data g_{R} suitable for the set size can be calculated from the interpolated luminance response curve.

The calculated 17×17 reference correction image data g_{R} is shown in FIG. 25. In FIG. 25, the horizontal axis indicates the target gray-scale g_{N}, and the vertical axis indicates the reference correction image data g_{R}. A plurality of curved lines correspond to the levels of the previous gray-scales g_{N-1}, respectively. In FIG. 25, a point of a third curved line from the upper side shows that the reference correction image data g_{R} is set to 145 levels when the previous gray-scale g_{N-1} having 32 levels is changed to the target gray-scale g_{N} having 96 levels.

After the reference correction image data g_{R} is calculated, the calculated reference correction image data g_{R} is stored in the storage unit 900 (S560) and the process is finished, ready to be repeated when desired.

In this way, according to the method of creating the reference correction image data according to the above-described exemplary embodiment of the present invention, a plurality of optical sensors is used to automatically create the reference correction image data. With this method, it is possible to reduce the number of measurements of a luminance waveform and thus to save the time required for the measurements. The method also allows the reference correction image data to be obtained without depending on the eyes of a measurer, ultimately making it possible to create accurate and optimum reference correction image data.

Although a liquid crystal display is used in the above embodiments, this is not a limitation of the present invention. For example, the present invention may be used with various other display devices, such as a plasma display device and an OLED display.

According to the above-described embodiments of the present invention, a plurality of optical sensors is used to automatically adjust a common voltage, set a reference gray voltage, and create reference correction image data. This use of optical sensors makes it possible to generate optimum common voltage, reference gray voltage, and reference correction image data in consideration of a characteristic deviation of each display device and to shorten the time required to manufacture the display device.

While this invention has been described in connection with what is presently considered to be practical exemplary embodiments, it is to be understood that the invention is not limited to the disclosed embodiments. On the contrary, the invention is intended to cover various modifications and equivalent arrangements included within the spirit and scope of the appended claims.

What is claimed is:

1. An apparatus for manufacturing a display device that includes a driving device and a first communication line connected to the driving device, the appratus comprising:
an image signal creating unit that creates image signals and transmits the image signals to the display device;
a plurality of optical sensors receiving light emitted from the display device and generating sensing signals;
a second communication line that is connectable to the first communication line; and
a signal processing unit that controls the image signal creating unit, receives the sensing signals, performs a predetermined process to create driving data for the display device, and transmits the driving data to the driving devices through the first and second communication lines.

2. The apparatus of claim 1, wherein the signal processing unit obtains initial driving data from the driving device through the first and second communication lines.

3. The apparatus of claim 1, wherein each of the optical sensors includes at least one sensing element.

4. The apparatus of claim 1, wherein the image signals have at least two different gray-scale levels at a plurality of positions.

5. The apparatus of claim 1, wherein the image signals have the same gray-scale level at a plurality of positions.

6. The apparatus of claim 5, wherein the signal processing unit corrects the optical sensors based on a difference between the sensing signals.

7. The apparatus of claim 1, further comprising a luminance measuring device that corrects the optical sensors.

8. The apparatus of claim 1, wherein the image signals have a pattern based on a polarity inversion mode of the display device.

9. The apparatus of claim 1, wherein the first and second communication lines are serial buses.

10. The apparatus of claim 9, wherein the serial buses are I²C buses.

11. The apparatus of claim 1, further comprising a jig that has a plurality of mounting members for mounting the plurality of optical sensors, the jig comprising a mechanism for adjusting positions of the mounting members based on luminance from a screen of the display device.

12. The apparatus of claim 1, wherein the driving data includes at least one of common voltage data, gray voltage data, and image-signal-correcting reference data of the display device.

13. The apparatus of claim 12,
wherein a plurality of flicker levels are calculated based on the plurality of sensing signals, and
the common voltage data is created based on an average flicker level and a deviation in the plurality of flicker levels.

14. The apparatus of claim 12,
wherein a plurality of flicker levels are calculated based on the plurality of sensing signals, and
the common voltage data is created such that an average flicker level of the plurality of flicker levels is reduced to a minimum.

15. The apparatus of claim 12, wherein the gray voltage data is created such that a target luminance corresponding to a gamma curve of the display device is substantially equal to a measured luminance corresponding to the sensing signal.

16. The apparatus of claim 12,
wherein the image signal is changed from a first gray-scale to a second gray-scale,
a response gray-scale is extracted from a luminance response after one frame from a point of time when the second gray-scale is changed, and
the image-signal-correcting reference data is created based on the first and second gray-scales and the response gray-scale.

17. The apparatus of claim 1, wherein the image signal creating unit creates a trigger signal synchronizing with a point of time when the frame is changed, and transmits the trigger signal to the signal processing unit.

18. The apparatus for manufacturing a display device of claim 1, wherein the sensing signal for the image signal is analyzed to recognize a point of time when the frame is changed.

19. The apparatus of claim 18, wherein the image signal is changed by changing one or more of a first gray-scale, a second gray-scale higher than the first gray-scale, and a third gray-scale higher than the second gray-scale sequentially for every frame.

20. A method of manufacturing a display device that includes a driving device and a communication line connected to the driving device, the method comprising:
transmitting image signals to the display device;
receiving light emitted from the display device at a plurality of positions to generate a plurality of sensing signals;
creating driving data for the display device based on the sensing signals; and
transmitting the driving data to the driving device through the communication line.

21. The method of claim 20, further comprising reading out initial driving data from the driving device through the communication line.

22. The method of claim 20, wherein the image signals have two different gray-scale levels at the plurality of positions.

23. The method of claim 20, wherein the image signals have the same gray-scale level at the plurality of positions.

24. The method of claim 20, wherein the image signals have a pattern based on a polarity inversion mode of the display device.

25. The method of claim 20, wherein the driving data includes at least one of common voltage data, gray voltage data, and image-signal-correcting reference data of the display device.

26. The method of claim 25, wherein the creating of the driving data comprises:
calculating a plurality of flicker levels based on the plurality of sensing signals;
calculating an average and a deviation of the plurality of flicker levels; and
creating the common voltage data using the average and the deviation.

27. The method of claim 25, wherein the creating of the driving data comprises:
calculating a plurality of flicker levels based on the plurality of sensing signals;
calculating an average of the plurality of flicker levels; and
creating the common voltage data such that the average has substantially the smallest value.

28. The method of claim 25, wherein the creating of the driving data comprises creating the gray voltage data such that a target luminance corresponding to a gamma curve of the display device is substantially equal to a measured luminance corresponding to the sensing signal.

29. The method of claim 25, wherein the image signal is changed from a first gray-scale to a second gray-scale, and wherein the creating of the driving data comprises:
extracting a response gray-scale from a luminance response after one frame from a point of time when the second gray-scale is changed; and
creating the image-signal-correcting reference data based on the first and second gray-scales and the response gray-scale.
